(19) United States
(12) Patent Application Publication
(10) Pub. No.: US 2020/0215768 A1
(43) Pub. Date: Jul. 9, 2020

(54) METHOD FOR MANUFACTURING A COMPACTED, COMPOSITE STIFFENER ASSEMBLY AND THE COMPACTED, COMPOSITE STIFFENER ASSEMBLY MANUFACTURED THEREBY

(71) Applicant: BOMBARDIER INC., Dorval (CA)

(72) Inventors: Mouhcine RIFAY, Montreal (CA); Alexandre DESHAIES, Terrebonne (CA); Kevin DUPUIS, Montreal (CA)

(21) Appl. No.: 16/606,939

(22) PCT Filed: Apr. 27, 2018
(86) PCT No.: PCT/US2018/029787

§ 371 Date: Oct. 21, 2019

Related U.S. Application Data
(60) Provisional application No. 62/491,738, filed on Apr. 28, 2017.

(51) Int. Cl. B29C 70/46; B29C 70/44

(52) U.S. Cl. CPC B29C 70/462; B29K 2307/04; B29C 70/443

(57) ABSTRACT

A method of compacting a plurality of pre-formed composite stiffeners prior to the plurality of pre-formed composite stiffeners being co-cured with a composite skin includes providing a caul plate with a plurality of stiffener receptacles and a skin-facing surface. The plurality of pre-formed composite stiffeners is positioned within the plurality of stiffener receptacles, each of the plurality of pre-formed composite stiffeners having a skin-contacting surface. A caul sheet having a mold surface that replicates a surface shape of the composite skin is positioned against the mold surface. The caul sheet is compacted against the caul plate such that the skin-contacting surfaces of the plurality of pre-formed composite stiffeners acquire the surface shape of the composite skin, thereby generating an assembly of compacted stiffeners.

### CROSS-REFERENCE TO RELATED APPLICATION(S)

This application relies for priority on U.S. Provisional Patent Application Ser. No. 62/491,738, entitled “METHOD FOR MANUFACTURING A COMPACTED, COMPOSITE STIFFENER ASSEMBLY AND THE COMPACTED, COMPOSITE STIFFENER ASSEMBLY MANUFACTURED THEREBY,” filed Apr. 28, 2017, the entire content of which is hereby incorporated by reference in its entirety.

### FIELD OF THE INVENTION

The present invention concerns a method for manufacturing a compacted, composite stiffener assembly. The present invention also encompasses the compacted, composite stiffener assembly manufactured by the method described herein.

### DESCRIPTION OF THE BACKGROUND AND RELATED ART

As should be apparent to those skilled in the construction of aircraft using composite materials, during the manufacture of portions of aircraft components, stiffeners are mated to the interior surface of the components to increase the strength and stiffness of those components. The components include, but are not limited to, the composite skin of an aircraft.

As also should be apparent to those skilled in the art, it is desirable to position the stiffeners as accurately as possible in relation to the skin so that the final composite skin is manufactured according to design specifications.

Still further, since the manufacture of aircraft parts is a repetitive task, it is desirable to have consistency between the manufacture of the parts in each iteration of the manufacturing process.

The prior art does not provide suitable solutions to one or more of the difficulties enumerated above.

### SUMMARY OF THE INVENTION

The present invention addresses one or more of the deficiencies with respect to the prior art.

In particular, the present invention provides a method of compacting a plurality of pre-formed composite stiffeners prior to the plurality of pre-formed composite stiffeners being co-cured with a composite skin. The method includes providing a caul plate defining a plurality of stiffener receptacles and a skin-facing surface. The plurality of pre-formed composite stiffeners is positioned within the plurality of stiffener receptacles, each of the plurality of pre-formed composite stiffeners having a skin-contacting surface. A caul sheet is provided with a mold surface that replicates a surface shape of the composite skin. The mold surface of the caul sheet is positioned against the skin-facing surface of the caul plate. The caul sheet is compacted against the caul plate such that the skin-contacting surfaces of the plurality of pre-formed composite stiffeners acquire the surface shape of the composite skin, thereby generating an assembly of compacted stiffeners.

In one contemplated embodiment of the present invention, the caul sheet is compacted against the caul plate under vacuum.

Still further, the method is contemplated to include positioning noodles in proximity to the skin-contacting surfaces of the plurality of pre-formed composite stiffeners such that compacting the caul sheet against the caul plate causes both the noodles and the skin-contacting surfaces to acquire the surface shape of the composite skin.

It is contemplated that the caul plate may be supported by a holding tool.

For the present invention, following compacting, the method also may include removing the caul sheet from the caul plate and placing the caul plate with the assembly of compacted stiffeners against the composite skin.

In another contemplated embodiment, the method includes co-curing the composite skin and the assembly of compacted stiffeners.

Still further, one contemplated embodiment of the method includes, via a plurality of rigid pins, securing the caul plate with the assembly of compacted stiffeners to a skin mold on which the composite skin is positioned.

It is contemplated that the caul plate with the assembly of compacted stiffeners is a first caul plate comprising a first assembly of compacted stiffeners. In this embodiment, the method includes placing a second caul plate with a second assembly of compacted stiffeners against the composite skin.

It is possible that the plurality of composite stiffeners may comprise a pre-preg material.

It is also anticipated that the composite stiffeners are closed-shaped stiffeners.

Still further, the plurality of composite stiffeners may include at least one of omega and delta shaped stiffeners.

The present invention also provides for an assembly. The assembly includes a caul plate that defines a plurality of stiffener receptacles and a skin-facing surface. The assembly also includes a plurality of pre-formed composite stiffeners positioned within the plurality of stiffener receptacles, each of the plurality of pre-formed composite stiffeners having a skin-contacting surface. Still further, the assembly has a caul sheet with a mold surface that replicates a surface shape of a composite skin with which the plurality of composite stiffeners is to be co-cured. An assembly of compacted stiffeners is generated by placing the mold surface of the caul sheet against the skin-facing surface of the caul plate and compacting the caul sheet against the caul plate such that the skin-contacting surfaces of the plurality of pre-formed composite stiffeners acquire the surface shape of the composite skin.

In one embodiment of the present invention, the assembly also includes noodles positioned in proximity to the skin-contacting surfaces of the plurality of pre-formed composite stiffeners.

The assembly also may have a holding tool supporting the caul plate.

It is contemplated, for a further embodiment of the present invention, that the assembly includes the composite skin.

For the assembly, the composite skin and the assembly of compacted stiffeners may be co-cured together.

The assembly of the present invention also may include a skin mold on which the composite skin is positioned and a plurality of rigid pins securing the caul plate with the assembly of compacted stiffeners to the skin mold.

The assembly of the present invention also may include a second caul plate with a second assembly of compacted stiffeners placed against the composite skin.

For the assembly, the plurality of pre-formed composite stiffeners may encompass a pre-preg material.

For the assembly, the plurality of pre-formed composite stiffeners may be closed-shaped stiffeners.

For the assembly, the plurality of pre-formed composite stiffeners may be at least one of omega and delta shaped stiffeners.

The present invention also provides a method of compacting a plurality of pre-formed composite stiffeners prior to the plurality of pre-formed composite stiffeners being co-cured with a composite skin. The method includes providing a caul plate with a plurality of stiffener receptacles and a skin-facing surface. The method includes positioning the plurality of pre-formed composite stiffeners within the plurality of stiffener receptacles, each of the plurality of pre-formed composite stiffeners having a skin-contacting surface and providing a caul sheet comprising a mold surface. The mold surface of the caul sheet is positioned against the skin-facing surface of the caul plate. Then, the caul sheet is compacted against the caul plate such that the skin-contacting surfaces of the plurality of pre-formed composite stiffeners acquire a shape of the mold surface.

Further aspects of the present invention will be made apparent from the paragraphs that follow.

### BRIEF DESCRIPTION OF THE DRAWING(S)

The present invention will now be described in connection with the drawings appended hereto, in which:

FIG. 1 is a perspective illustration of a first embodiment of the assembly of the present invention;

FIG. 2 is a perspective view of the first embodiment of the assembly illustrated in FIG. 1, providing an enlarged detail of selected details of the assembly;

FIG. 3 is a perspective illustration of a holding tool contemplated for use with the present invention;

FIG. 4 is a perspective illustration of a skin mold for use in connection with the present invention;

FIG. 5 is a flow chart illustrating selected aspects of the method according to one or more embodiments of the present invention; and

FIG. 6 is a flow chart illustrating selected, optional, additional steps that may be employed with the method illustrated in FIG. 5.

### DETAILED DESCRIPTION OF EMBODIMENT(S) OF THE INVENTION

The present invention will now be described in connection with one or more embodiments thereof. The discussion of the embodiments is not intended to be limiting of the present invention. To the contrary, any discussion of specific embodiments is intended to exemplify the breadth and scope of the present invention. As should be apparent to those skilled in the art, variations and equivalents of the embodiment(s) described herein may be employed without departing from the scope of the present invention. Those variations and equivalents are intended to be encompassed by the scope of the present patent application.

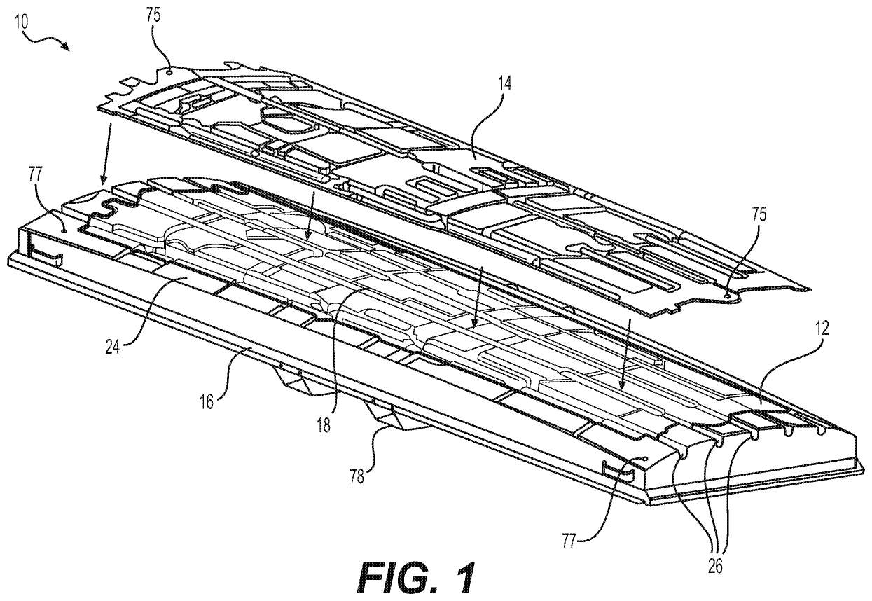

FIG. 1 is a perspective illustration providing an overview of a first embodiment of an assembly 10 according to the present invention. In a broad aspect of the present invention, the assembly 10 includes a caul plate 12. The assembly 10 also includes a caul sheet 14 that is disposable atop the caul plate 12 and is used for compacting a plurality of pre-formed composite stiffeners 20. In the illustrated embodiments, the caul plate 12 is positioned on a holding tool 16 adapted to provide enhanced rigidity to the caul plate 12.

It is contemplated that the caul plate 12 may be made from any from a number of suitable materials including, but not limited to, metals, alloys, ceramics, and composites. Exemplary materials from which the caul plate 12 may be constructed include, but are not limited to iron, alloys of iron, steel, alloys of steel, aluminum, alloys of aluminum, ceramics, plastics, composites, and combinations of materials including one or more of the listed materials, among others. It is anticipated that the caul plate 12 may be made from aluminum and/or an alloy of aluminum, but the present invention should not be understood to be limited solely to this construction. As should be apparent to those skilled in the art, the caul plate 12 may be made from any material that is considered to be well-suited for the manufacture of components from composite materials.

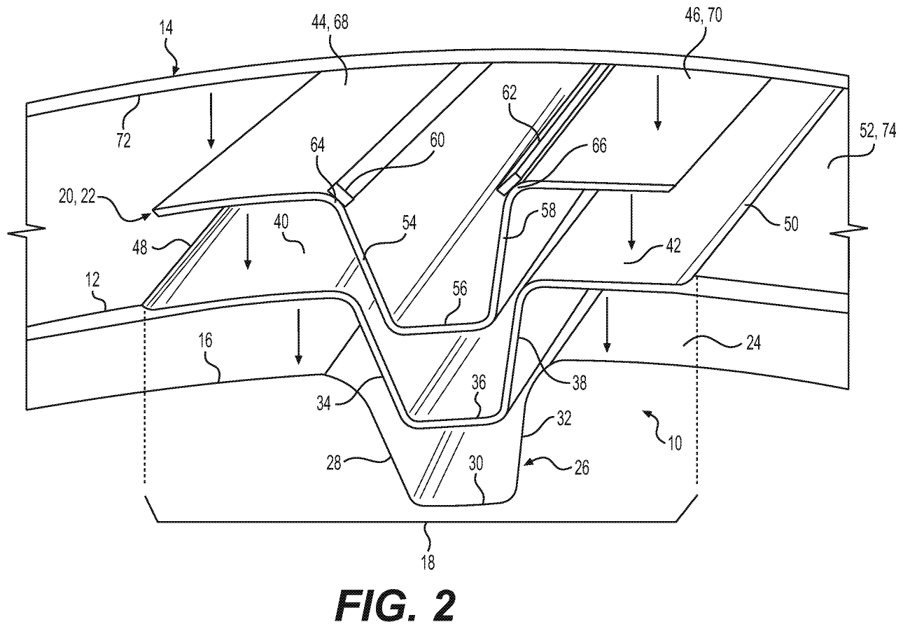

Broadly, the caul plate 12 includes at least one stiffener receptacle 18. However, in most contemplated embodiments, the caul plate 12 includes a plurality of stiffener receptacles 18 for receiving stiffeners 20 (shown in FIG. 2).

FIG. 2 provides an enlarged cross-section of one of the stiffener receptacles 18. The illustrated stiffener receptacle 18 has a generally trapezoidal shape.

As should be apparent to those skilled in the art, the stiffener receptacle 18 that is illustrated in FIG. 2 is merely illustrative of one contemplated shape for the stiffener receptacles 18 of the present invention. The stiffener receptacles 18 may have any shape suitable to create compacted stiffeners 22, as discussed in greater detail herein. For example, the stiffener receptacles 18 may incorporate curved lines, straight lines, and combinations of the two without departing from the scope of the present invention. The stiffener receptacles 18 may be suitable for receiving open-shaped stiffeners 20 or closed-shaped stiffeners 20, such as omega or delta shaped stiffeners.

As noted, the caul plate 12 is contemplated to include a plurality of stiffener receptacles 18. Each of the stiffener receptacles 18 may have the same shape. In an alternative construction, each of the plurality of stiffener receptacles 18 may have different shapes and constructions from one another. In other words, the present invention does not require all of the stiffener receptacles 18 to have the same shape and/or configuration. It is anticipated that one or more of the stiffener receptacles 18 will differ from others of the stiffener receptacles 18 on the same caul plate 12.

Still further, the caul plate 12 is contemplated to present the plurality of stiffener receptacles 18 in a predetermined pattern or arrangement. For the manufacture of different components, each caul plate 12 may include a different pattern or arrangement for the plurality of stiffener receptacles 18, as required or as desired for a particular component.

In accordance with the embodiment shown in FIG. 1, the plurality of stiffener receptacles 18 are arranged in a substantially uniform manner, with each stiffener receptacle 18 being substantially parallel to the other stiffener receptacles 18. In addition, the spacing between the plurality of stiffener receptacles 18 is substantially the same. However, it should be appreciated that one or more of the plurality of stiffener receptacle 18 may be positioned non-parallel to one or more of the other stiffener receptacles 18 and the spacing between each of the stiffener receptacles 18 may be non-uniform and vary between stiffener receptacles 18.

The caul plate 12 is constructed to receive a pre-formed composite stiffener 20 in each of the stiffener receptacles 18. The pre-formed composite stiffeners 20 that are placed within the stiffener receptacles 18 will be compacted to form compacted stiffeners 22, as described in greater detail herein.

The pre-formed composite stiffeners 20 are contemplated to be made from a composite material. As should be understood by those skilled in the art, the composite material most likely employed with the assembly 10 of the present invention is a carbon fiber composite. A carbon fiber composite typically involves a plurality of layers of carbon fibers laid atop one another. The carbon fibers may be woven and/or non-woven. A resin occupies the interstices between the carbon fibers to create the carbon fiber composite, once cured.

While carbon fiber composites are contemplated for use with the present invention, the present invention is not intended to be limited to carbon fiber composites. The present invention is intended to encompass composite materials now known and composite materials developed in the future. For example, the composite may include one or more materials including aramid fibers. Still further, the composite material may include one or more honeycomb layers and/or materials. Where conductivity is desired, the composite may include a metal mesh, metal film, and/or metallized fibers. As should be apparent, the composite material may include a wide variety of additional materials and/or equivalents to carbon fibers without departing from the scope of the present invention.

As will be described in greater detail below, the pre-formed composite stiffeners 20 are compacted while positioned on the caul plate 12, thereby resulting in the formation of compacted stiffeners 22. The caul plate 12 is contemplated to exhibit at least some degree of flexibility. As such, the caul plate 12 is contemplated to be positioned within a holding tool 16 to provide sufficient rigidity to permit the pre-formed composite stiffeners 20 to be compacted within the caul plate 12.

After compaction, it is contemplated that the compacted stiffeners 22 will be released from the caul plate 12. Accordingly, the caul plate 12 may be constructed with a surface that facilitates release of the compacted stiffeners 22 therefrom. For example, the surface of the caul plate 12 may incorporate a release material therein. Still further, the surface of the caul plate 12 may be coated with a release material before the pre-formed stiffeners 20 are deposited thereon. In one further embodiment, the surface of the caul plate 12 may be provided with a release film.

With continued reference to FIGS. 1 and 2, it is contemplated that the caul plate 12 will be received in the holding tool 16 such that the caul plate 12 is supported by the holding tool 16. Furthermore, it is contemplated that the holding tool 16 may be designed to accommodate a plurality of different caul plates 12. Accordingly, the holding tool surface 24 may present a different number of holding tool receptacles 26 than the stiffener receptacles 18 in the caul plate 12. Of course, the holding tool 16 may include a number and pattern of holding tool receptacles 26 that is complimentary of the stiffener receptacles 18, as illustrated in FIG. 2.

In the embodiment illustrated in FIG. 2, the holding tool receptacles 26 are trapezoidally-shaped. While illustrative of one contemplated embodiment of the present invention, the holding tool receptacles 26 may have any suitable shape without departing from the scope of the present invention.

As illustrated in FIG. 2, each of the holding tool receptacles 26 includes a first side 28, a bottom 30, and a second side 32. The holding receptacles 26 extend downwardly from the holding tool surface 24.

The caul plate 12 includes the stiffener receptacles 18, as discussed above. Each of the stiffener receptacles 18 also are trapezoidally-shaped. As such, each of the stiffener receptacles 18 has a first side 34, a bottom 36, and a second side 38. A first flange forming portion 40 extends laterally from the first side 34 of the stiffener receptacle 18. Similarly, a second flange forming portion 42 extends laterally from the second side 38 of the stiffener receptacle 18. The first flange forming portion 40 assists with the formation of the first flange 44 on the pre-formed composite stiffener 20. Similarly, the second flange forming portion 42 assists with the formation of the second flange 46 on the pre-formed composite stiffener 20.

The first flange forming portion 40 terminates at a first chamfer 48. The second flange forming portion 42 terminates in a second chamfer 50. In the illustrated embodiment, the first chamfer 48 and the second chamfer 50 are illustrated as approximately a 45° angle with respect to the caul plate surface 52. The angle of the chamfers 48, 50, however, is not critical to the present invention. The chamfers 48, 50 may have any angle between 0° and 90° without departing from the scope of the present invention.

With continued reference to FIG. 2, the illustrated pre-formed composite stiffener 20 is trapezoidally-shaped. As discussed above, the shape of the pre-formed composite stiffener 20 may be changed from the illustrated shape without departing from the scope of the present invention. The pre-formed composite stiffener 20 includes a first flange 44 and a second flange 46 that connect to a first side 54, a bottom 56, and a second side 58.

Consistent with the present invention, the pre-formed composite stiffeners 20 may be formed by depositing a pre-constructed laminate into the stiffener receptacles 18. Alternatively, the pre-formed composite stiffeners 20 may be deposited, layer-by-layer, into the stiffener receptacles 18. In either case, prior to the compaction process that will be described in more detail below, the composite layers of each pre-formed composite stiffeners are generally compressed together using techniques known for pre-forming composite stiffeners.

As shown in FIG. 2, in accordance with a non-limiting embodiment, it is contemplated to add first noodle 60 and second noodle 62 to each pre-formed composite stiffener 20. The noodles 60, 62 assist with the formation of the compacted stiffeners 22 at the first transition 64 and the second transition 66. The transitions 64, 66 are locations where the composite material may present a manufacturing gap due to the radius of curvature of the composite material at these locations. The noodles 60, 62 fill these gaps during manufacture to effectuate a stronger bond between the compacted stiffeners 22 and the composite skin 76. The noodles 60, 62 may be made from any material, as should be appreciated by those skilled in the art.

A deficiency with existing methods of joining pre-formed composite stiffeners 20 to a composite skin, is that the flanges 44, 46, and sometimes the noodles 60, 62, do not sit flush with the caul sheet 12. Accordingly, when the caul plate 12 containing the plurality of these un-compacted composite stiffeners 20 is placed against the composite skin and cured together, movement and shifting of the composite stiffeners 20 in relation to the skin can occur. This can lead to an undesirable positioning of the cured stiffeners in relation to the skin, which can lead to finished parts that do not conform with design requirements, as well as a lack of repeatability and reliability of the curing process.

The process and assembly according to the present invention for compacting the plurality of composite stiffeners 20 aims to reduce, at least partly, this deficiency.

Referring back to FIG. 1, the caul sheet 14 is suitable for pressing against the caul plate 12, the pre-formed composite stiffeners 20, and optionally the noodles 60, 62, permitting the pre-formed composite stiffeners 20 to be compacted, thereby forming the compacted stiffener 22 that have flanges 40, 46 that have acquired a shape that will sit flush on an eventual composite skin to which they are to be co-cured.

As shown in FIG. 2, the plurality of pre-formed composite stiffeners 20 include skin contacting surfaces in the form of a first skin-contacting surface 68 on the first flange 44 and a second skin contacting surface 70 on the second flange 46.

The caul sheet 14 includes a mold surface 72 that replicates a surface shape of a composite skin 76 with which the plurality of compacted stiffeners 22 are to be co-cured. An assembly of compacted stiffeners 22 is generated by placing the mold surface 72 of the caul sheet 14 against the skin-facing surface 74 of the caul plate 12 and compacting the caul sheet 14 against the caul plate 12 such that the skin-contacting surfaces 68, 70 of the plurality of pre-formed composite stiffeners 20 acquire the surface shape of the composite skin 76. One or more indexation holes 75 may be provided in the caul sheet 14 to facilitate alignment with the caul plate 12, as should be apparent to those skilled in the art.

The first and second noodles 60, 62 are positioned in proximity to the skin-contacting surfaces 68, 70 of the plurality of pre-formed composite stiffeners 20.

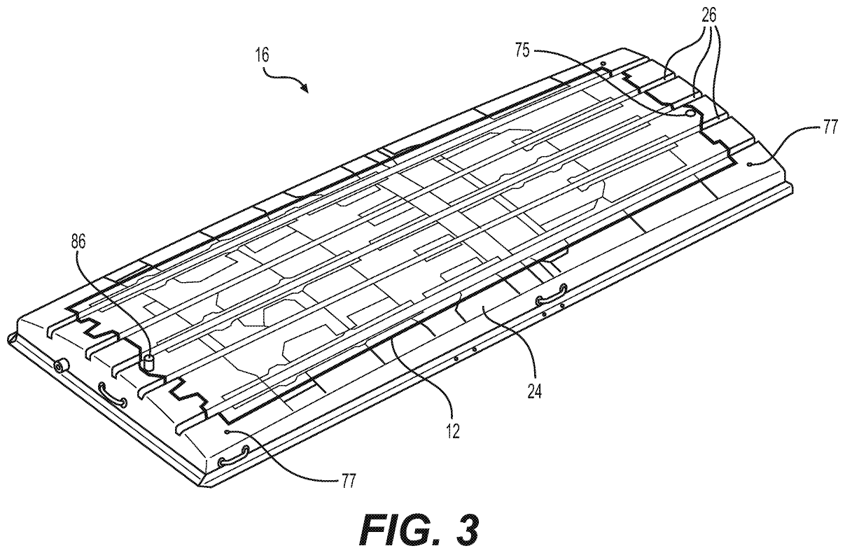

FIG. 3 is a perspective illustration of one contemplated embodiment of the holding tool 16 according to the present invention. As noted above, the holding tool 16 supports the caul plate 12. The caul plate 12 may be secured to the holding tool 16 in any manner desired and/or required. The holding tool 16 includes a frame 78 that supports the holding tool surface 24.

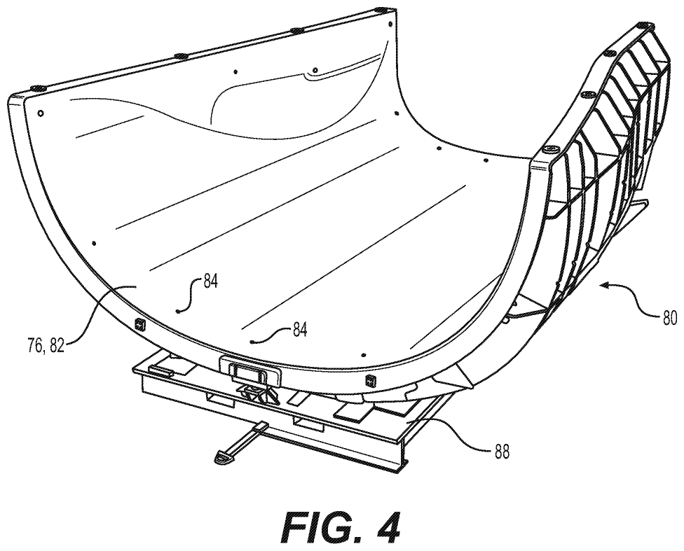

FIG. 4 is a perspective illustration of a skin mold 80. The composite skin 76 is disposed onto the mold surface 82 of the skin mold 80. The composite skin 76 may be deposited onto the skin mold 80 in any suitable manner known to those skilled in the art. For example, the composite skin 76 may be formed from a number of sheets of composite material layered atop one another. Still further, the composite skin 76 may be constructed from the deposition of composite tape layered onto the skin mold 80.

The skin mold 80 includes a plurality of holes 84 that are in register with a number of pins 86 disposed on the holding tool 16 at the location(s) of the indexation holes 75. One of the pins 86 is shown in FIG. 3 to illustrate one contemplated location for the pins 86. It is noted that a pin 86 is omitted from the indexation hole 75 at the opposite end of the holding tool 16 so that the indexation hole 75 is visible. However, in practice, it is contemplated that a pin 86 also will be disposed in this indexation hole 75. When the holding tool 16 is mated with the skin mold 80 after the compacted stiffeners 22 are formed, the pins 86 are inserted into the holes 84. The pins 86 secure the holding tool 16 and the caul plate 12 to the skin mold 80, ensuring that the compacted stiffeners 22 are properly positioned against the composite skin 76.

As should be apparent from FIG. 4, the pins 86 are located on the holding tool 16 and the holes 84 are disposed in the skin mold 80. It is contemplated that the pins 86 may be disposed on the skin mold 80 and that the holes 84 disposed in the holding tool 16 without departing from the scope of the present invention.

Still further, in another contemplated embodiment, the pins 86 may be located on the caul plate 12, as illustrated in FIG. 2. Alternatively, the holes 84 may be located on the caul plate 12. In this configuration, the caul plate 12 may be mated to the skin mold 80 without the holding tool 16.

As noted herein, the pre-formed composite stiffeners 20 may be compacted using a vacuum. If so, vacuum holes 77 may be provided in the holding tool 16.

Since the pre-formed composite stiffeners 20 are compacted to form compacted stiffeners 22 before the caul plate 12 is placed against the skin mold 80, the first and second skin contacting surfaces 68, 70 of the compacted stiffeners 22 are properly compacted so as to acquire the surface shape of the composite skin 76. As a result, the caul plate 12 and holding tool 16 sit more predictably on the skin 76 and skin mold 80, such that the pins 86 may be constructed from a rigid material. Rigid materials include, but are not limited to iron, alloys of iron, steel, alloys of steel, aluminum, alloys of aluminum, ceramics, and/or composites.

In one contemplated embodiment of the present invention, the assembly 10 includes a second caul plate 12 with a second assembly of compacted stiffeners 22 placed against the composite skin 76. Still further, the assembly 10 may encompass any number of caul plates 12 to establish a suitable pattern and distribution of compacted stiffeners 22 on the composite skin 76.

As illustrated in FIG. 4, the skin mold 80 may include a skin mold frame 88 to reinforce the skin mold 80 and the mold surface 72.

As should be apparent from the foregoing, the plurality of pre-formed composite stiffeners 20 may be made from pre-preg materials. Pre-preg materials encompass carbon fiber fabrics that are pre-impregnated with resin but not cured. It is noted that pre-preg materials are not required to practice the present invention.

As should be apparent from the foregoing, the pre-formed composite stiffeners 20 and the compacted stiffeners 22 are closed-shaped stiffeners. The stiffeners 20, 22 may have an omega shape or a delta shape in contemplated embodiments of the present invention.

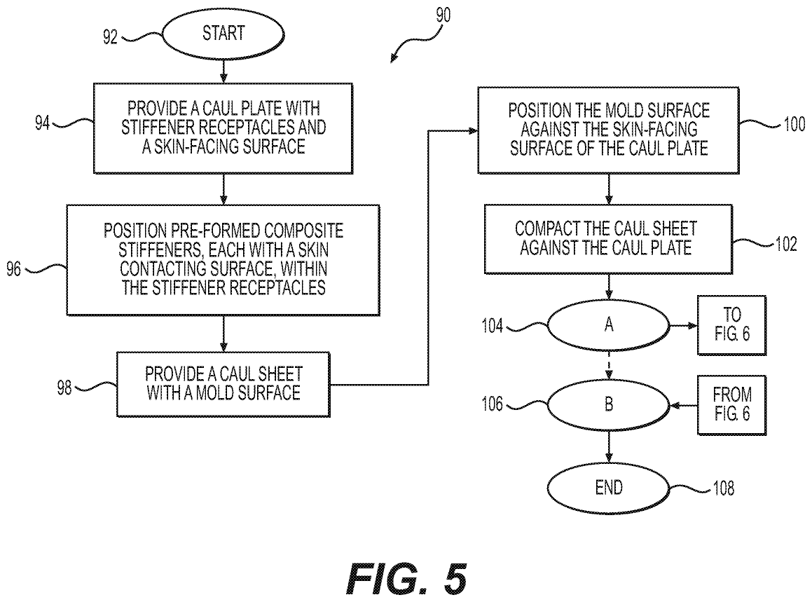

With reference to FIG. 5, the present invention also encompasses a method 90 of compacting a plurality of pre-formed composite stiffeners 20 prior to the plurality of pre-formed composite stiffeners 20 being co-cured with a composite skin 76.

In the discussion that follows, the method 90 is discussed in terms of steps. For clarity, the term “step” is not intended to refer to a discrete step that is entirely independent of any other step. To the contrary, the term “step” is used merely to assist with the description of the method 90. The identification of any particular “step,” therefore, should not be understood to be limiting of the present invention. Moreover, while some steps logically precede or follow other steps, the presentation of the order of steps also should not be understood to limit the present invention. One or more steps may be performed out of sequence from the method 90 illustrated in FIG. 5 without departing from the scope of the present invention, as should be apparent to those skilled in the art.

With continued reference to FIG. 5, the method 90 begins at step 92.

The method 90 proceeds to step 94 where the caul plate 12 is provided. As discussed above, the caul plate 12 includes a plurality of stiffener receptacles 18 and a skin-facing surface 74.

At step 96, the plurality of pre-formed composite stiffeners 20 are positioned within the plurality of stiffener receptacles 18. As noted above, each of the plurality of pre-formed composite stiffeners 20 include skin-contacting surfaces 68, 70.

At step 98, the caul sheet 14 is provided. The caul sheet 14 includes a mold surface 72 that replicates a surface shape of the composite skin 76.

At step 100, the mold surface 72 of the caul sheet 14 is positioned against the skin-facing surface 74 of the caul plate 12. In particular, the caul sheet 14 is laid atop the caul plate 12. One or more release materials may be incorporated into and/or applied to the mold surface 72 of the caul sheet 14 to facilitate release from, among other structures, the skin-contacting surfaces 68, 70 of the pre-formed composite stiffener 20. Alternatively, a release film (not shown) may be inserted between the caul plate 12 and the caul sheet 14, as required or as desired.

At step 102, the caul sheet 14 is compacted against the caul plate 12 such that the skin-contacting surfaces 68, 70 of the plurality of pre-formed composite stiffeners 20 are caused to acquire the surface shape of the composite skin 76, thereby generating an assembly of compacted stiffeners 22. As noted above, an assembly of compacted stiffeners 22 encompasses one or more individual compacted stiffeners 22.

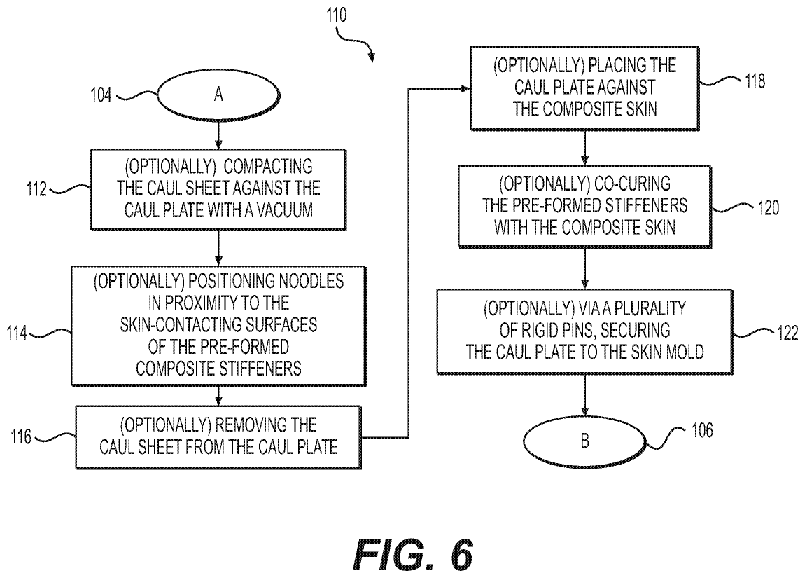

Step 104 is a transition point in the method 90. Specifically, the transition point 104 indicates that the method 90 may transition to optional steps 110, which are illustrated in FIG. 6.

Step 106 also is a transition point in the method 90. If any of the optional steps 110 provided in FIG. 6 are employed, step 106 indicates the return from the optional steps 110 to the method 90.

The method 90 ends at step 108. If none of the optional steps 110 are employed, the method 90 proceeds from step 102 to step 108, as should be apparent from FIG. 5.

If the method 90 proceeds to any of the optional steps 110 illustrated in FIG. 6, the method 90 may include the optional step 112 of compacting the caul sheet 14 against the caul plate 12 under a vacuum. A vacuum may have any strength or magnitude as should be apparent to those skilled in the art. A vacuum bag may be required to assist with compacting under a vacuum.

Step 114 concerns the positioning of the noodles 60, 62 in proximity to the skin-contacting surfaces 68, 70 of the plurality of pre-formed composite stiffeners 20 such that compacting the caul sheet 14 against the caul plate 12 causes both the noodles 60, 62 and the skin-contacting surfaces 68, 70 to acquire the surface shape of the composite skin 76.

Optionally, the method 90 may incorporate the steps 116 and 118. At step 116, the caul sheet 14 is removed from the caul plate 12. At step 118, the caul plate 12 with the assembly of compacted stiffeners 22 is placed against the composite skin 76.

At step 120, the composite skin 76 and the assembly of compacted stiffeners 22 may be co-cured.

At step 122, via a plurality of rigid pins 86, the caul plate 12 with the assembly of compacted stiffeners 22 may be secured to a skin mold 80 on which the composite skin 76 is positioned.

Still further, the method 90 may include placing a second caul plate 12 with a second assembly of compacted stiffeners 22 against the composite skin 76. As noted above, a plurality of caul plates 12 may be combined to establish a desired pattern of compacted stiffeners 22 on the composite skin 76.

As noted above, the embodiment(s) described herein are intended to be exemplary of the wide breadth of the present invention. Variations and equivalents of the described embodiment(s) are intended to be encompassed by the present invention, as if described herein.

What is claimed is:

1. A method of compacting a plurality of pre-formed composite stiffeners prior to the plurality of pre-formed composite stiffeners being co-cured with a composite skin, the method comprising:
providing a caul plate defining:
a plurality of stiffener receptacles; and
a skin-facing surface;
positioning the plurality of pre-formed composite stiffeners within the plurality of stiffener receptacles, each of the plurality of pre-formed composite stiffeners comprising a skin-contacting surface;
providing a caul sheet comprising a mold surface that replicates a surface shape of the composite skin;
positioning the mold surface of the caul sheet against the skin-facing surface of the caul plate;
compacting the caul sheet against the caul plate such that the skin-contacting surfaces of the plurality of pre-formed composite stiffeners acquire the surface shape of the composite skin, thereby generating an assembly of compacted stiffeners.

2. The method of claim 1, wherein compacting the caul sheet against the caul plate is performed under vacuum.

3. The method of claim 1, further comprising:
positioning noodles in proximity to the skin-contacting surfaces of the plurality of pre-formed composite stiffeners such that compacting the caul sheet against the caul plate causes both the noodles and the skin-contacting surfaces to acquire the surface shape of the composite skin.

4. The method of claim 1, wherein the caul plate is supported by a holding tool.

5. The method of claim 1, wherein following compacting, the method further comprises:
removing the caul sheet from the caul plate; and
placing the caul plate comprising the assembly of compacted stiffeners against the composite skin.

6. The method of claim 5, further comprising:
co-curing the composite skin and the assembly of compacted stiffeners.

7. The method of claim 5, further comprising:
via a plurality of rigid pins, securing the caul plate comprising the assembly of compacted stiffeners to a skin mold on which the composite skin is positioned.

8. The method of claim 5, wherein the caul plate comprising the assembly of compacted stiffeners is a first caul plate comprising a first assembly of compacted stiffeners, the method further comprising:
placing a second caul plate comprising a second assembly of compacted stiffeners against the composite skin.

9. The method of claim 1, wherein the plurality of pre-formed composite stiffeners comprise a pre-preg material.

10. The method of claim 1, wherein the plurality of pre-formed composite stiffeners are closed-shaped stiffeners.

11. The method of claim 10, wherein the plurality of pre-formed composite stiffeners comprise at least one of omega and delta shaped stiffeners.

12. An assembly, comprising:
a caul plate defining:
a plurality of stiffener receptacles; and
a skin-facing surface;
a plurality of pre-formed composite stiffeners positioned within the plurality of stiffener receptacles, each of the plurality of pre-formed composite stiffeners comprising a skin-contacting surface; and
a caul sheet comprising a mold surface that replicates a surface shape of a composite skin with which the plurality of composite stiffeners are to be co-cured,
wherein an assembly of compacted stiffeners is generated by placing the mold surface of the caul sheet against the skin-facing surface of the caul plate and compacting the caul sheet against the caul plate such that the skin-contacting surfaces of the plurality of pre-formed composite stiffeners acquire the surface shape of the composite skin.

13. The assembly of claim 12, further comprising:
noodles positioned in proximity to the skin-contacting surfaces of the plurality of pre-formed composite stiffeners.

14. The assembly of claim 12, further comprising:
a holding tool supporting the caul plate.

15. The assembly of claim 12, further comprising the composite skin.

16. The assembly of claim 15, wherein the composite skin and the assembly of compacted stiffeners are co-cured together.

17. The assembly of claim 15, further comprising:
a skin mold on which the composite skin is positioned; and
a plurality of rigid pins securing the caul plate comprising the assembly of compacted stiffeners to the skin mold.

18. The assembly of claim 15, further comprising:
a second caul plate comprising a second assembly of compacted stiffeners placed against the composite skin.

19. The assembly of claim 12, wherein the plurality of pre-formed composite stiffeners comprise a pre-preg material.

20. The assembly of claim 12, wherein the plurality of pre-formed composite stiffeners are closed-shaped stiffeners.

21. The assembly of claim 20, wherein the plurality of pre-formed composite stiffeners comprise at least one of omega and delta shaped stiffeners.

22. A method of compacting a plurality of pre-formed composite stiffeners prior to the plurality of pre-formed composite stiffeners being co-cured with a composite skin, the method comprising:
providing a caul plate defining:
a plurality of stiffener receptacles; and
a skin-facing surface;
positioning the plurality of pre-formed composite stiffeners within the plurality of stiffener receptacles, each of the plurality of pre-formed composite stiffeners comprising a skin-contacting surface;
providing a caul sheet comprising a mold surface;
positioning the mold surface of the caul sheet against the skin-facing surface of the caul plate; and
compacting the caul sheet against the caul plate such that the skin-contacting surfaces of the plurality of pre-formed composite stiffeners acquire a shape of the mold surface.
